(19) United States
(12) Patent Application Publication
(10) Pub. No.: US 2007/0112621 A1
(43) Pub. Date: May 17, 2007

(54) Method for automatic determination and charging for the use of a paid parking area

(76) Inventors: Norbert Miller, Monchengladbach (DE); Markus Schneider, Monchengladbach (DE)

Correspondence Address: HARNESS, DICKEY & PIERCE, P.L.C., P.O. BOX 828, BLOOMFIELD HILLS, MI, 48303, US

(21) Appl. No.: 11/586,347

(22) Filed: Oct. 25, 2006

(30) Foreign Application Priority Data
Oct. 25, 2005 (EP) 05023204.0

(51) Int. Cl. G07B 15/00

(52) U.S. Cl. 705/13

(57) ABSTRACT

The invention is directed to a method for the automatic determination and charging for the use of a paid parking area as well as a transmitting apparatus for the method in accordance with the invention, a user terminal in accordance with the invention as well as a method for the status query of the user terminal in accordance with the invention, and an auxiliary unit as well as a method for the operation of the auxiliary unit. It is the object of the present invention to provide a method, which overcomes the above-identified disadvantages and additionally enables a repeatably usable parking permit. As the solution to the above-identified object, a method for the automatic determination and charging for the use of a paid parking area is provided, wherein data packets are transmitted from a transmitting device in the area of the parking area over a wireless, unidirectional communications connection, the data packets are received and further processed by a user terminal located within a vehicle that is parked in the parking area.

The invention is directed to a method for the automatic determination and charging for the use of a paid parking area as well as a transmitting device for the method in accordance with the invention, a user terminal in accordance with invention as well as a method for querying the status of the user terminal in accordance with the invention, and an auxiliary unit as well as a method for the operation of the auxiliary unit.

With the use of paid parking places, it has long since been necessary to acquire a corresponding authorization for parking after the automobile has been properly parked, in which, for example, a corresponding parking permit that is printed on paper is acquired at an automated parking machine that is located in the parking area and the parking permit is visibly left inside the vehicle. With this variant, it is necessary that the user already knows how long he intends to park at the time of acquiring the parking permit, because the parking fee is often dependent upon the length of time the vehicle is parked. A further possibility for the collection of parking fees is provided in the installation of parking meters, wherein the user of the parking space inputs an amount corresponding to the planned parking duration into the parking meter, whereby the parking meter displays a release signal for the planned time period. This method for the payment of parking fees also includes the above identified disadvantages.

Furthermore, a variant for the payment of the parking fees is known, with which a paper permit having a magnetic strip is taken by the user from a gate in the entrance area of the parking area, whereupon the access to the parking area is granted. At the end of the period of use, a fee is paid at a machine installed in the parking area, wherein a release for exiting is marked on the parking permit by the machine, which allows the user to leave the exit area of the parking area.

With regard to both of the initially identified methods, it is disadvantageously established that the user must already know the exact parking duration at the beginning of the parking in order to acquire a corresponding parking authorization. If the user requires clearly less parking time as originally planned, the unused sum goes to the favor of the parking area operator. If, on the other hand, the planned parking duration is surpassed for unforeseeable reasons, it is thus necessary that the user purchases another parking authorization on time, before the expiration of the parking authorization. If the user is hindered, further fines threaten because of the infringement of the regulations.

The last identified method eliminates theses disadvantages, however, it proves as problematic that the magnet strips of the parking permit can be damaged, whereby the data is no longer available, or also that the parking permit can be lost by the user. In this case, increased payments, for example, to the amount of a daily fee or the like are provided as a rule, in order to eliminate a process for the infringement of the regulations. The risk with respect to the parking permit lies on the user side alone.

A further possibility for the payment of parking fees presents itself through the use of mobile telephones. Herewith, it is necessary to register and deregister by means of the mobile telephone at the beginning and at the end of the parking period. Automatic location recognition is not possible with this method.

It is the object of the present invention to provide a method, which overcomes the above identified disadvantages and furthermore enables a repeatedly usable parking permit.

As the solution to the above-identified object, a method for the automatic determining and charging for the use of the paid parking area is provided, wherein data packets are transmitted over a wireless, unidirectional communications connection by a transmitting device in the area of the parking area. The data packets are received by a user terminal located in the parked vehicle in the parking area and are further processed.

At first, it is possible with the present invention, to realize a highly flexible, automatic parking authorization by means of the user terminal. The user terminal receives the data packets from the transmitting device and further processes these. Therewith, a data set can be generated, on the basis of which a charging of the parking fees can occur. As a particular advantage, it has been shown that, on the one hand, the user must no longer carry along the parking permit and, on the other hand, a charging at a there installed machine is not necessary either before or after leaving the parking space. A high flexibility and user friendless can be achieved. Thus, exists, for example, the possibility to accumulate the parking fees of the individual uses and to charge the parking fees at a later point in time, wherein the possibility can furthermore be provided to give bonuses and other discounts. The invention enables automatic determination of whether a paid parking occurrence, a cost free parking event or an as agreed operation of the vehicle exists. This can be achieved such that, for example, reception signals are evaluated. If multiple reception signals with the same reception strength and/or the same transmitting identification and/or operator identification are received one after another, a parking event can be determined therefrom and the payment requirement, if necessary. An action by a user is thereby not strictly necessary. As soon as namely the received signal changes, for example, in which its field strength increases or decreases or an identification of a data packet or of an operator changes, this can be detected as the ending of the parking occurrence and the charging is ended. Naturally, the determination of vehicle operating conditions can be used in order to determine whether a parking occurrence is existent. Thus, for example, an engine condition or a locking condition of the doors can be queried in order to ascertain the operating condition.

Preferably, the transmitting device is installed in the parking area and covers the parking area with its transmitting range such that the data packets can be securely received by the user terminal at each parking space. The unidirectional communications connection can, for example, be formed by a radio connection, infrared connection or the like. Because the communications connection is solely unidirectional, the data packets can be concurrently received by a plurality of user terminal without the complex protocols that would be observed, such as those that are necessary for the bidirectional communications connection. Through this, the communications and processing effort can be considerably reduced. Furthermore, an efficient fee processing can be achieved with a plurality of user terminals, because the further processing is provided in the user terminals themselves. A response to the transmitting device is not provided. The data packets contain the information that the user terminal needs in order to be able to charge for the use of the parking space as intended. The data packet can contain, for example, information about the tariff for the parking fee.

It is further proposed that the data packets are time-discretely transmitted. In this manner, the transmitting energy can be saved. The data packets can be transmitted, for example, in second or minute cycles.

It is furthermore recommended that the data packets contain at least one of the following information: an operator identification number, a sequence number, a date, a time, location information and/or a parking area identification. Consequently, the data packet enables the exact parking time and parking duration as well as an identification of the parking area to be made available for a later use for charging. The determined fee of the operator of the parking area can be assigned with the operator identification number.

In a further embodiment, it .is proposed that data sets regarding the parking beginning and/or parking ending are generated from the received data packets by means of the user terminal and are stored. In this manner, it can be advantageously achieved that the parking fees can be charged at a later point in time. Thereby, this embodiment further enables that, for example, advantages and bonuses can be considered at a later point in time. This further embodiment also allows an exact debiting of the fees to be achieved for several different operators.

In a further embodiment, it is proposed that a data packet uses an identification number of the user terminal. It can be advantageously achieved that data is sent, which is only used by a specific user terminal and, in fact, the user terminal that includes the associated identification number. As a result, rebates and bonuses can be time-discretely considered. For example, an operator of a department store with a restricted parking area can access the transmitting device and the data packets transmitted therefrom directly over a network. A customer, who fulfills specific conditions to acquire a bonus and designates the identification number of his user terminal to the checkout of the department store, can enjoy the bonus in this manner, in which the transmitting device is supplied with corresponding information over the network and transmits the corresponding information with the bonus in a subsequent data packet. The unidirectional transmitted data packets are received by all of the user terminals in the transmitting range. However, only the user terminal with the corresponding identification number considers this data packet. It is furthermore proposed that a data packet uses an identification number of a group of several user terminals. In an analogous manner, it can be achieved that a bonus of a pre-given group of user terminals is assigned.

In a further embodiment, it is proposed that the user terminal indicates its current status. Through this, whether the user posses a valid parking authorization can be determined at the parked vehicle at anytime and within the scope of a parking area monitoring. The indication can occur, for example, by means of an alpha-numeric character in a display of the user terminal or also through another optical signal output, such as a light-emitting diode, an LCD indicator segment or the like. If an authorization exists, the indication reacts accordingly. If, in contrast, an authorization does not exist, the indication remains without an indicated value or the indication does not react in accordance with an authorization and signals this in another manner, for example, in the form of an error indication or the like.

It is furthermore proposed that the indication is produced by a special data packet. This data packet can be, for example, a query data packet, which induces the user terminal to indicate its current status. Through this, it can be achieved that the status of the user terminal can be queried solely by authorized personnel. In time periods outside of a monitoring, the indication can be without an indicated value or can also be switched off.

In a further development it is proposed that the current status is temporarily indicated. This embodiment enables that the user terminal is operated as energy efficiently as possible. Furthermore, it can be achieved that the status is not indicated to unauthorized third parties. Thus, it can be provided, for example, that the special data packet produces the indication and the indication is automatically deleted after a predetermined indication time.

In a further embodiment it is proposed that the current status is indicated based on a received signal energy. Thus, it can be provided that a minimum energy in addition to the data packet must be received, in order for the user terminal to indicate the current status. This embodiment enables that the indication only occurs if sufficient energy for the operation of the user terminal is provided through the reception of the signal energy.

It is furthermore proposed that a pre-paid credit is saved in the user terminal. In this manner, it can be achieved that, for example, the credit is reduced by a predetermined amount with the reception of each of the data packets. It can, however, also be provided that the data packet contains an amount to be charged, which is respectively debited from the credit. The credit can be stored, for example, in the form of valued points or the like, or also in the form of currency values.

It is furthermore proposed that the credit is loaded. Thus, it can be provided, for example, that the user terminal is provided with a credit at a loading terminal. For this purpose, the loading terminal can accept, for example, currency or also charge through bank connections, credit cards, cash cards or the like. The credit is stored in the user terminal. The crediting terminal can be in communications connection with a control center through a data network such as the Internet or the like. It can also be configured as “stand-alone” equipment without a permanent communications connection to a control center.

In a further development, it is proposed that the loading occurs automatically. This embodiment enables that the user terminal can be loaded at a loading station that is provided for this purpose without manual action of the Advantageously, this method offers, for example, continuous parking, wherein the data is transferred to the user terminal solely over the interface inclusive of potential bonuses or discounts without a manual intervention of the user.

In order to achieve the possibility of providing a simple charging for the loading of the user terminal, it is proposed that a value of a credit of an account is determined and is made available for the loading over a network. The account can be, for example, a credit and/or debit account, wherein a balancing can be produced through billing organizations or the similar via Internet and/or debit note, and wherein the value of the credit to be loaded from this account is debited from this account for the loading of the user terminal at the loading terminal.

In one embodiment it is proposed that the value of the credit to be loaded is ascertained at a loading terminal that is connected with the network. Advantageously, the user has the possibility to determine the amount of the credit himself. In this manner, he can himself determine the value of the credit of the user terminal according to appropriate discretion.

In an advantageous further development, it is proposed. that an amount specified in the data packet is charged. In this manner, it is possible to adjust the tariff for the parking fee in a quasi-discretionary manner and to correspondingly charge the credit in the user terminal. A high flexibility relative to the tariff structure can be achieved, wherein, for example, higher tariffs can be provided for periods of denser use and correspondingly lower tariffs for less dense use periods.

It is further proposed that the amount to be debited from the user terminal is determined by means of the received data packet and an executable program that is stored in the user terminal. Advantageously, the data packets can be further processed in this manner in order to make features available for use. It can also merely be provided that the data packets are stored. After evaluating the data, an amount to be charged, however, can also be debited from the credit provided in the user terminal. It is, however, also possible that the user terminal receives data packets with the cooperation of the program, without debiting the credit of the user terminal. This is, for example, advantageous when a parking authorization is available in a residential parking area or a parking space has been rented, which is invoiced monthly, for example, by means of a fixed amount.

In a further development, it is proposed that a use event is stored in the user terminal. In this manner, the possibility is created to hold the use events available for a later evaluation.

It is additionally proposed that a use event that is stored in the user terminal is transmitted to a control center during the loading of a credit onto the user terminal. Thus, the possibility exists to transmit the use events stored in the user terminal to the control center for the purpose of further data processing. Thus, it can be provided, for example, that rebates and bonuses are granted based on the number and the type of use events.

Furthermore, it is proposed that the use events transmitted to the control center can be used for the differentiation of the use of different operators. Thus, it can be achieved, for example, that the control center takes over the charging of the parking fees and transmits to each operator the amount of parking fees in total that corresponds to him. The control center can execute such a charging, for example, daily, weekly or also monthly. A reduction of the accounting effort can be achieved on the operator's side.

It is additionally proposed that the receiving energy is used for the energy supply. Through this, it can be achieved that an energy storage for the operation of the user terminal can be further reduced. In the ideal case, a separate energy storage is not necessary, but rather the reception energy is used in order to guarantee the intended function of the user terminal. Costs can be spared.

It is furthermore proposed that the stored data is transmitted to a control center. This can occur, for example, at the loading of the user terminal with a credit at a loading terminal, wherein the stored data is read from the user terminal over an interface and is transmitted over a communications connection to the control center. The interface can be executed either wirelessly or also wired. It can be formed as, for example, a close-range radio or infrared interface,. as well as a contactable contact field. Thus, it can be provided, for example, that a charging of the parking fees occurs monthly, wherein the charging can be provided per debit entry through the control center. For this purpose, the user has the account with the control center at his disposal, which is charged corresponding to the accrued fees in accordance with the tariff. Furthermore, this embodiment enables that, with different parking area operators, the parking fees entitled to them are centrally transmitted. This can be achieved in that the data, for example in the form of data sets, contain operator identifications. This is an advantage for the parking area operator, who must no longer deal with the collection of the parking area fees, because this is taken over by the control center.

In order to ensure that the data stored in the user terminal and the actual use authorization can be assigned, it is proposed that the user terminal is registered at the control center for the transmitting of the data stored in the user terminal. The registration can, for example, occur by means of an identification, which is unique for each user terminal and/or group of user terminals. The user terminal can include, for example, a transmitting unit, which is able to come into communications connection with a corresponding receiving unit of the central office. In contrast to the mere debiting of the parking fees from the credit, for which only a unidirectional communications connection is provided, a bidirectional communications connection is provided for the transmitting of the data to the control center. The bidirectional communications connection, however, is solely used for the transferring of the data to the control center and for the loading of the credit. Therefore, it is also not necessary to design the transmitting unit for a permanent communications connection. In this manner, material requirements as well as also energy consumption can be reduced.

It is additionally proposed that the user terminal is de-registered after the transmission of the stored data. The user terminal thusly, does not have to be in direct communications connection with the control center for the exercise of its intended function. This enables the number of communications channels between the control center and the user terminals to be held low. Thus, it can be provided, for example, that additional communications means are provided in the entrance and/or exit areas of the parking surface, which are in communications connection with the control center and which enable a bidirectional communications channel with the user terminal to be produced. Preferably, the information capacity of the communications connection is selected such that, for example, the event of the registration, of the transmission of the stored data and of the de-registration can be phased out with the passing of the vehicle by the communications means. Through this, a communications connection of shorter range can likewise be employed so that the required transmitting and receiving means are designed only for a low performance. The transmitted data can be, for example, start and end times of the parking space use as well as also operator identification and the like, so that a precise charging with the operators can be carried out over the control center. The transmission of the data to the control center can occur, for example, over a wireless or also a wired communications connection. A wireless communications connection can be, for example, a radio connection, an infrared connection or the like. The communications means can be provided, for example, in the form of points positioned alongside of a roadway.

In a further embodiment of the present invention, it is proposed that the user terminal communicates with an auxiliary unit over an interface. The use of an auxiliary unit enables that the user terminal can be provided exclusively for a unidirectional reception of data packets. The user terminal as well as the auxiliary unit respectively includes an interface, over which they can communicate with one another. The interface can be, for example, a wired interface based on contact or also a wireless interface based on radio, such as Bluetooth or the like, or also an infrared interface. The auxiliary unit can transmit data regarding, for example, tariff zones, tariff structure or the like to the user terminal. In this manner, it is possible to adapt the user terminal to very different systems by means of an auxiliary card, without separate user terminals being necessary for this.

Naturally, it can be provided that the data stored in the user terminal is transmitted to the auxiliary unit. Through this, it can be achieved, on the one hand, that a memory unit of the user terminal must be designed with a comparably lower memory capacity. Alongside of this, the possibility exists with mobile auxiliary units to conveniently forward the data to given transaction points that are in communications connection with the control center, with whom transaction points the data can be transmitted to the control center by means of the auxiliary unit. Through this, the user terminal can be advantageously fixedly installed in the vehicle. The data that is obtained from the user terminal can be transmitted from the auxiliary unit to the control center. A direct communications connection between the user terminal and the control center can be foregone.

An interface for close-range communication can be provided as the communications connection between the user terminal and the auxiliary unit, which, for example, is based on infrared or short-range radio. A Bluetooth standard or an arrangement in accordance with ISO 14443 can be provided as the protocol, particularly if the user terminal includes an energy source and/or is coupled with the energy source of the vehicle, wherein the auxiliary unit is itself provided with energy from the communications connection between the user terminal and the auxiliary unit. This allows very compact and handy auxiliary units to be created.

Naturally, it can also be provided that a credit is entered on the auxiliary unit. This enables the auxiliary unit such as a cash card, for example, to be used, because a monetary value can be included on its memory. Accordingly, a credit can be transmitting in a quasi-discretionary manner with the auxiliary unit.

Building on this, it is proposed that a credit is transferred from the auxiliary unit to the user terminal. Thus, a credit can be advantageously transferred by simple means, in particular with user terminals that are fixedly installed in the vehicle, so that this can be used as intended. For this purpose, a credit can be credited at a corresponding transaction unit, such as an automated teller, onto the auxiliary unit within the scope of a communications connection and of a transaction, which credit is deposited in the memory of the auxiliary unit. With the auxiliary unit, a communications connection can then be produced through the interface to the user terminal, to which the credit or at least a portion thereof can be transmitted thereafter. In this manner, the user terminal can be attached to the vehicle, wherein the user terminal can be, at the same time, formed very compactly and cost-efficiently, because it does not require a transmitting unit, with which it must come into communications connection with the control center. This furthermore allows an energy storage for the operation of the user terminal to be further reduced with regard to its capacity.

In a further embodiment, it is proposed that the data stored in the user terminal be deleted after or with the transfer. In this manner, the required memory can be held small and new memory space for additional memory action can be created.

In accordance with a further embodiment, it is proposed that an operator identification number, a sequence number, a date, a time, location information and/or a parking area identification is input into the user terminal. This enables the user to set-up the user terminal for a pre-determined operating mode. Thus, it can be provided that, for example, the user terminal can only be activated for pre-determined parking areas. If the user terminal receives data packets from parking areas that are not cleared, it remains deactivated.

In a further embodiment, it is proposed that the data packet contains an identification of the transmitting unit. In this manner, the user terminal can identify data packets from different transmitting devices, in order to prohibit, for example, double charging and the like. This is then particularly advantageous if the parking area is monitored by several transmitting devices, which include overlapping areas and the vehicle is parked in such an overlapping area. It receives then, for example, data packets from several transmitting devices. Naturally, in this manner, an delineation of neighboring, different managed parking spaces is also achieved, in which, for example, a user inputs a parking area identification in the user terminal and the user terminal solely reacts to data packets from the transmitting device with this parking area identification. Through this, conflict situations can be resolved.

With the invention is further proposed a transmitting device for the method in accordance with the invention, the transmitting device having a data processing unit, a transmitting device for producing a unidirectional communications connection as well as an energy source, wherein a data set with a company identification number, a sequence number, a date, a time, location information and/or a parking space identification is generatable by means of the data processing unit, and is transformable into a transmittable data packet by means of a transmitting unit. Preferably, the transmitting device is exclusively provided for the transmission of data and can therefore be very simply and robust and cost-efficiently constructed. Advantageously, data sets can be generated and transmitted with the transmitting device, which enables a debiting of a credit stored in the user terminal, or which enables fees to be determined and charged at a later point in time. Retention of the tariffs within in the transmitting device is not necessary with the latter embodiment, because the parking fees are at first determined in the control center itself when charging over a control center. A high flexibility can be achieved.

In one embodiment, it is proposed that several transmitting units are located in the parking area. This embodiment enables the parking area, which is to be monitored, to be covered in an appropriate manner. Thus, with a parking structure, for example, it can be provided that a transmitting unit is located in each level. Alongside of this, it can be provided that each sub-area includes its own transmitting unit for thickly structured parking spaces, whose sub-areas enclose, for example, arrangements, which do not allow the parking area to be covered with a single transmitting unit.

In a further development, it is proposed that the transmitting units are operable in master-slave operation. Thus, it can be achieved that the transmitting units do not influence one another and a disturbance occurs with reception in the user terminal. Thus, it can be provided that, for example, the transmitting devices transmit at different frequencies or in time division or the like.

It is furthermore proposed that each transmitting unit includes its own identification number. Through this, it can be achieved that the user terminal distinctly acknowledges a transmitting unit assigned to it. Thus, it can be provided that, for example, the user terminal acknowledges the initially identified transmitting unit as the transmitting unit that is proper for it. Further, the user terminal therefore reacts only to the data packets with this identification number. A secure determination of the parking fees can be achieved.

Further, it is proposed that the identification number is contained in the respectively transmitted data packet. This embodiment enables multiple charges to be identified on the basis of the data packets of different transmitting devices received through the user terminal. Multiple charges can be avoided.

Because the transmitting device can be controlled as needed, it is proposed that the transmitting device includes a communications connection to a control center. Tariff time periods and tariff zones can be pre-determined or altered, for example, over the control center, which thereby leads to the transmitting device transmitting different data packets. The flexibility of the parking area management can be further improved.

A user terminal for the method in accordance with the invention is further proposed with the invention, which includes a receiving unit, a memory unit, a processing unit as well as a display unit.

The user terminal can be advantageously very compactly constructed. Because its own transmitting unit is not required, the expense for the transmitting unit as well as for a possibly required energy storage for the transmission can furthermore be spared. Through this, the user terminal can not only be very compactly, in particular also, it can be very light and cost-efficient.

In a further development, the user terminal includes an input unit, which can be constructed, for example, as a key. It can be provided that the user either activates or deactivates the user terminal by operating this key. Furthermore, also further functions can be provided, thus, for example, the query of data, which is stored in the user terminal.

In one embodiment, it is recommended that the user terminal includes an interface. The interface can be either contact free or can require contact. As a contact free interface, it is preferably constructed as a close-range interface. It can be constructed as an infrared interface, as a close-range radio interface or the like. It can furthermore be constructed as a Bluetooth interface or also based on the standard ISO 14443. As a contact requiring interface, a contact surface field with corresponding contact surfaces can be provided, which can be brought into electrical connection with corresponding counter contacts, spring contacts in particular. The interface can thereby be provided for transmitting the data to a corresponding receiver, which transmits data at its end to a control center in order to execute the later charging. It can also thereby be provided to load a credit memory of the user terminal with a credit. Thereby, the interface can be connected with a loading terminal, which enables a credit to be stored in the user terminal. The interface can thereby also be used to enable an authentication for the entrance to protected areas. Thus, for example, the authentication of a parking space and/or of a parking garage can be ensured with a spatially zoned area, which should not be accessible to the public. A connection is produced over the interface and an entrance control of the non-public areas of the parking area, which ensures the authorized user entrance and/or exit. Through this, a charging of parking fees can occur after as well as before through the unidirectional transmitted data packets. The bidirectional function can be provided, for example, for the opening of gates in protected entrance area through the interface.

It is furthermore proposed that the user terminal includes a transponder. The intended function of the method in accordance with the invention can be advantageously realized by means of the transponder. Alongside of this, it can be provided that the transponder is provided for the administration of the credit and to its loading. Advantageously, components that are already commercially available can be implemented. Cost and development efforts can be reduced.

In a further, advantageous development, it is proposed that the user terminal includes a chip-card formed housing. This enables the user terminal to be conveniently carried, for example, on distance travel, and respectively locally arranged in the vehicle in order to be able to charge corresponding parking fees. The chip-card formed housing enables the user terminal to be constructed very compactly and light. Furthermore, standard methods for the production and the storing can be used. Alongside of this, the user terminal can also include a coin shaped housing.

Furthermore, it is proposed that the housing includes a contact surface for the production of a wired communications connection. Thus, for example, the possibility exists to provide the user terminal with a credit at a loading terminal such as is the case with cash cards. This embodiment also enables costs for the user terminal to be reduced. Furthermore, the possibility exists to likewise use already known cash card terminals for the loading of cash cards for the loading of the user terminal with a credit. This enables the expense for the realization of a system based on the present invention to be simplified.

In order to be able to transmit. the data stored in the user terminal, it is proposed that the user terminal includes a transmitting unit for the transmitting of stored data. The transmitting unit can preferably be connected with the interface or also include the interface. The transmitting unit can retrieve the data from the memory unit of the user terminal and make the data available for the transmitting. The transmitting unit can further code the data for the transmitting in an appropriate manner, in which, for example, a block coding, a convolution coding, combinations thereof or the like can be provided. Furthermore, an encryption of the data for transmitting can be provided in order to be able to reduce an unauthorized access to the data. Furthermore, the data security can be increased. The transmitting unit can itself include a corresponding electronic circuit for this purpose, which is arranged to communicate with the memory unit. With a wireless interface, the transmitting unit can furthermore include corresponding transmitting means, for example, an infrared transmitting diode, a transmitting antennae or the like.

In order to further improve the application area of the user terminal, it is proposed that the user terminal includes an input unit. The input unit can exist, for example, in one or several keys, which can be constructed electro-mechanically or also purely electronically. Preferably, ten numeric keys as well as an input key and a delete key are provided. Furthermore, an alphanumeric input unit can also naturally be provided. Also, the input unit can be formed as a single piece with the display unit, for example, in the form of a touch sensitive screen, so that a menu management can be realized on the user side. Thus, for example, it can be provided that, for example, the user terminal is already pre-programmed with respect to the approved operator identification and the user only has to select the desired identification. The operation of the user terminal can be simplified with increased functionality.

Furthermore, it is proposed that the user terminal include a checking unit. The checking unit enables the authorization to be checked, in particular if settings on the user terminal should be carried out or data from the user terminal should be queried. For this purpose, the transmitting and/or input of an authorization code can be requested, which are encrypted if necessary. The security can be further improved.

Furthermore, it is proposed that the user terminal includes an accumulation unit. With the accumulation unit, a positive accounting event in the form of the transmission of a credit as well as a negative accounting occurrence in the form of a debiting can be executed.

Further, it is proposed that the user terminal includes a housing with an additional function unit. Thus, the user terminal can be combined, for example, with other electronic equipment, like, for example, MP3 players, mobile radio equipment and the like, in order to reduce the number of the hand held devices carried by the user. Furthermore, costs can be reduced.

Furthermore, it is proposed that the housing is formed as a parking disk, a parking permit or a parking authorization. By looking at the form of the housing, the user can recognize that it is a user terminal, which he requires for a parking authorization. The user terminal can be easily differentiated from several devices of another nature. Advantageously, the user terminal is formed as a parking disk so that it can be applied at fee free parking spaces having time limited usage periods.

An auxiliary unit with an interface as well as with a first memory unit is proposed with the invention, which auxiliary unit includes a second memory unit for an authorization value. The auxiliary unit is provided for implementation with the user terminal. It serves for the purpose of storing a credit on the user terminal as well as accessing stored data if required, especially in the case of a fixed installation of the user terminal in the vehicle. For this purpose, the auxiliary unit includes at least one interface, with which it can come into communications connection with an interface of the user terminal. It is understood that the interface is appropriately constructed for communication with the interface of the user terminal. Naturally, the auxiliary unit can also include several interfaces if required, which can come into communication connection with different, additional units, in order to be able to perform the intended function. It is particularly advantageous, however, if the implemented interface can be concurrently used for several units. In this manner, the expense related to material and energy consumption can be spared. The first memory unit can be implemented, for example, for the storage of data that is accessed from the user terminal. The auxiliary unit can thereby serve as an intermediary between the control center and the user terminal. In this manner, the user terminal can be exclusively provided for the unidirectional reception of the data packets. It does not have to directly come into communications connection with a control center or a unit associated with the control center, whereby the expense. and the energy consumption of the user terminal can be reduced. The auxiliary unit can be constructed in the form of a check card for example, or the like. It can furthermore include an energy storage, which, in the case of a communication with the user terminal, transfers energy to the user terminal. Naturally, an inverse case can also be provided, in particular if the user terminal is connected with an energy supply of the vehicle.

It is further proposed that the auxiliary unit is portable. In this manner, a higher mobility can be achieved. Furthermore, it can be provided that several auxiliary units are provided, which can come into communications connection with the user terminal or also several user terminals. Thus, it can be provided that, while he has parked his vehicle in a paid parking premises and the user terminal is active, the user furnishes the auxiliary unit with a credit at corresponding facilities, which he transfer to the user terminal upon return to the vehicle. The flexibility can be further improved. Alongside of this, stationary auxiliary units can also naturally be provided at a merchant, for example, or the like, which are located in the parking area itself or the like. Thus, it can be provided that, with leaving of the parking premises, a previously approved credit is accessed upon demand by a stationary located auxiliary unit in the exit area of the parking premises and is transferred to the user terminal, as has already been indicated initially.

In order to ensure that credits and/or data are only transferred to authorized recipients, it is proposed that the auxiliary unit includes an identification number. Through this, the authorization of the recipient, for example, of the user terminal or also of the control center can be checked before a data transfer. The security can be further improved. Naturally, the identification unit can itself also include an authorization, which is transferred to the corresponding recipients upon demand, in order to be able to initiate a data exchange.

In accordance with a further development, the first and second memroy units are constructed as one piece. Through this, costs can further be spared.

A method for the operation of the auxiliary unit in accordance with the invention is further proposed with the invention, wherein a pre-determinable value of the auxiliary unit is added to an accumulated value of the user terminal, wherein the to be accumulated value is compared with an authorized value that is stored in the auxiliary unit, wherein the accumulation occurs only within the scope of the authorized value. With the method, it can be achieved that the auxiliary unit can transfer a credit to the user terminal only in the amount for which it has an authorization. A misuse can be made difficult. It can be provided that the auxiliary unit transfers only a portion of the value for which it has an authorization to the user terminal. The value of the credit that is to be transferred can be selected the user if necessary by a corresponding input over an input unit. The value that is to be added is compared with the stored authorization value and, if the value that is to be added is below the authorization value, the value that is to be added is transmitted to the user terminal. At the same time, the authorization value is adapted to the value that is to be added and/or is reduced. The user can accordingly transfer to the user terminal a value that is to be added as a credit in the amount of the authorization value. The transfer to the user terminal in excess of the authorization value is restricted. If this is not high enough, the value to be added can be limited to the authorization value or the transmission can be aborted.

Furthermore, it is proposed that the authorization value is approved using a transaction point. Preferably, the transaction point is in communications connection with the control center. The transaction point enables, for example, a credit to be transferred to the auxiliary unit. This occurs in that a transaction at the transaction point, in particular a payment transaction, is conducted, whereupon the transaction point releases an approval for an authorization value to the auxiliary unit that is brought into communications connection with the transaction point. The transaction point can be, for example, a vending machine or the like. The authorization value can be provided in the form of a monetary value or also in the form of another unit such as value points or the like. In accordance with a further development, it is proposed that the accumulation occurs in the form of a subtraction from the authorization value. Accordingly, the authorization value on the auxiliary unit respectively decreases by the value, which is transmitted to the user terminal. As soon as the authorization value is zero, a credit can not be transmitted to the user terminal.

Alongside of this, it can also be provided that the accumulation occurs in the form of an addition. In this case, a transfer of the credit to a user terminal can only occur in the amount of the authorization value. If, for example, several user terminals are provided with a credit from a single auxiliary unit, the individual values that were transmitted to the user terminals are summed. As soon as the summed value achieves the authorization value, a further transfer of credits to the user terminals can no longer be executed. If a credit provided to the user terminal exceeds the authorization value, an interruption of the function can be provided or a credit can be restricted to the available value.

A method for querying the status for a user terminal is further proposed with the invention, wherein a query data packet is transmitted over a unidirectional close-range communications channel, the query data packet is received by the user terminal and the query data is displayed. This embodiment enables it to be ascertained, in a simple manner, whether an authorization for parking is present. Thus, it can be provided, for example, that a controller approaches the to be checked vehicle with a mobile transmitting device and there activates the user terminal by means of the transmitting of the query data packet, which thereupon displays the query data. The query data can, for example, therein confirm that merely one light-emitting diode indicates an authorization condition. Alongside of this, however, also other, additional data can be queried, for example, the beginning of the parking period, the credit still available or for how long a parking authorization has expired or the like.

Further, it is proposed that a close-range radio connection or an infrared connection be used as the close-range communications channel. The close-range radio connection can be based on the Bluetooth standard or similar, for example. With little effort, a query of data from the user terminal can be achieved.

In accordance with a further embodiment, it is proposed that the auxiliary unit is at least occasionally brought into communications connection with a control center by means of an interface, that an authorization value from the control center can be deposited in a memory unit of the auxiliary unit or that an accumulated value is accessed from the memory unit and the communications connection is ended upon the release of the authorization value. In this manner, an authorization value can be concurrently transferred from the control center to the user terminal and the data obtained from the user terminal can be transmitted to the control center. Because the communications connection upon release of the authorization value is ended, it has the advantage that the auxiliary unit does not have to remain in permanent communications connection with the control center and, therefore, the number of communications connections can be held low. The communications connection is required only for the duration of the communications connection; that means for the transfer of the data as well as the release of the authorization value and the transmission of the amount of the authorization value. If the communications connection is ended, it stands available for a further auxiliary unit. Naturally, in the case of the addition, it can be provided that, instead of the clearance of the authorization value, an accumulated value is accessed from the memory unit and is set to zero in the memory unit of the auxiliary unit. The auxiliary unit is then in a position to again transfer a credit to the user terminal, wherein the individual values are again summed until reaching the authorization value. In this case, the clearance occurs through the control center such that the accumulated value is backed up in the memory unit. Naturally, it can also be provided that the communications connection is not produced until after a registration procedure with the control center.

In accordance with a further proposal, an allotted value is implemented. This enables, for example, the memory unit to be simplified, because only a number of allotments have to be managed. Effort can be further reduced.

In accordance with a further proposal, an identification is used for the production of the communications channel with the control center. The identification can exist, for example, in the form of an alpha-numeric code, which can furthermore be encrypted. It can further be provided that the identification requests the use of a specific encryption for the data transfer. Through this, the security of the data can be further improved. The identification can be bilaterally provided so that it identifies both the control center and also the auxiliary unit. The identification can be provided from the factory, it can, however, be customizable by the user or an authorized third party if required.

It is furthermore proposed that the release occurs through a payment transaction. For this purpose, it can be provided, for example, that the control center initiates a payment transaction during the existence of the communications connection, with which a person that is required to pay, the user for example, carries out a payment to the control center, and, only after a successful payment transaction, the control center transmits the release to the auxiliary unit. Alongside of this, the release can also otherwise occur, in which, for example, weekly or monthly invoices are transmitted to the person that is required to pay. In this case, a release occurs until the next payment date. It can be further provided that the release can occur for only a maximum authorization value. This can, for example, be predetermined by the control center and/or also by the user himself.

It is furthermore proposed that the communications connection with the control center be produced at pre-determinable time intervals. Thus, it can be provided that the communications connection is produced weekly, monthly or the like. If the production of the communications connection does not happen, a further release of an authorization value can be declined.

Naturally, several auxiliary units can also be cascaded. Thus, it can be provided that authorization values are transferred from one auxiliary unit to another auxiliary unit. In return, the transfer of data can be provided, which is accessed from the user terminal beforehand. Naturally, it can also be provided that an auxiliary unit is located stationary, for example, in the area of the sales point and a further auxiliary unit in the possession of the user. The user can then obtain, for example, a rebate or a bonus in the form of a credit from the stationary unit, for example, a commercial transaction, in which the pre-determinable value is transmitted to the auxiliary unit of the user. In this manner, the value of the stationary unit can, for example, be reduced by the transmitted value, wherein the value of the user-side auxiliary unit is increased by a corresponding value.

A method for querying the status for the user terminal in accordance with invention is further proposed with the invention, wherein a query data packet is transmitted, the query data packet is received by the user terminal and the query data is displayed. In this manner, it is possible that an authorized third party can check the status of the user terminal. The query data packet can be transmitted, for example, by the transmitting device in accordance with the invention or also from a separate, transportable unit. For this purpose, the data packet preferably contains pre-determinable authorization information, which can be checked by the user terminal. The query data is not displayed until a valid authorization is received by the user terminal. The display preferably occurs on a display of the user terminal itself. The authorization. can be provided for a group of user terminals. Naturally, the user terminal can also be provided for a query on the basis of several different authorizations, thus, for example, if the same user terminal should be used in different parking areas of different operators. Authorized control personnel, which preferably use a different authorization for each parking area, can query the status of the user terminal. This allows the user to use his user terminal at managed parking areas of different operators without undertaking actions for this purpose. The user terminal does not have to send back a signal for this. purpose, in particular it displays only its current status on the display unit. The display can occur, for example, through an indication such as “ok” or also through displaying of the current credit. Naturally, it can also be provided that additional status data of the user terminal is displayed, for example, a park beginning, a forecast maximum parking duration or the like. For this purpose, the query data packet can include additional query information, which allows the display of this data. Thus, it can be provided that the breadth of the status query of the user terminal occurs authorization specifically, so that the status value of the user terminal is displayed in dependence on the authorization that is released for the display. The breadth of the displayed status information can be transmitted to the user terminal in line with the tariff information.

In a further development, it is proposed that the query data packet is transmitted over a close-range communications channel. This has the advantage that an encroachment in the transmitting device can be avoided. The transmitting device can therefore be continuously further operated independently of a local query of the status of the user terminal. The query preferably occurs by means of a portable hand device, which is carried by authorized personnel. The hand device transmits a corresponding data packet on demand, which can be received by the user terminal. Through this, it can be achieved that only those user terminals present within the area of interest display their status. Preferably, the close-range communications channel is, with respect to it coverage, limited such that only a single user terminal can react to the transmitted data packet. The coverage of the communications channel, in this case, preferably amounts to 0.5 to 1 m. Naturally, it can also be provided that the communications connection is so configured that only the user terminal in the corresponding solid angle can react to the data packet.

Furthermore, it is suggested that a close-range radio connection or an infrared communications connection is used as the close-range communications channel. A selective status query of a user terminal can be achieved, because a good directivity can be achieved with correspondingly known measures.

In a further development, it is proposed that the transmitting device of the invention is used for the transmission of the query data packet. The query data packet can be directly transmitted from the transmitting device installed in the parking area in time-wise random intervals or regular intervals. It can also be provided that this signal is manually initiated by a controller at the transmitting device. Advantageously, it can be achieved that the controller is not required to carry along his own equipment for checking the user terminals.

In order to reduce communication interferences, it is proposed that the query data packet is uni-directionally transmitted. This enables a reception unit that is already provided in the user terminal to be used for the status query. A transmitting unit can be spared. This saves effort and energy.

Further advantages and features are provided from the following description of an exemplary embodiment. Largely, like components are indicated with the same reference numbers. The drawings are schematic drawings and only serve for the explanation of the following exemplary embodiment.

It is illustrated in:

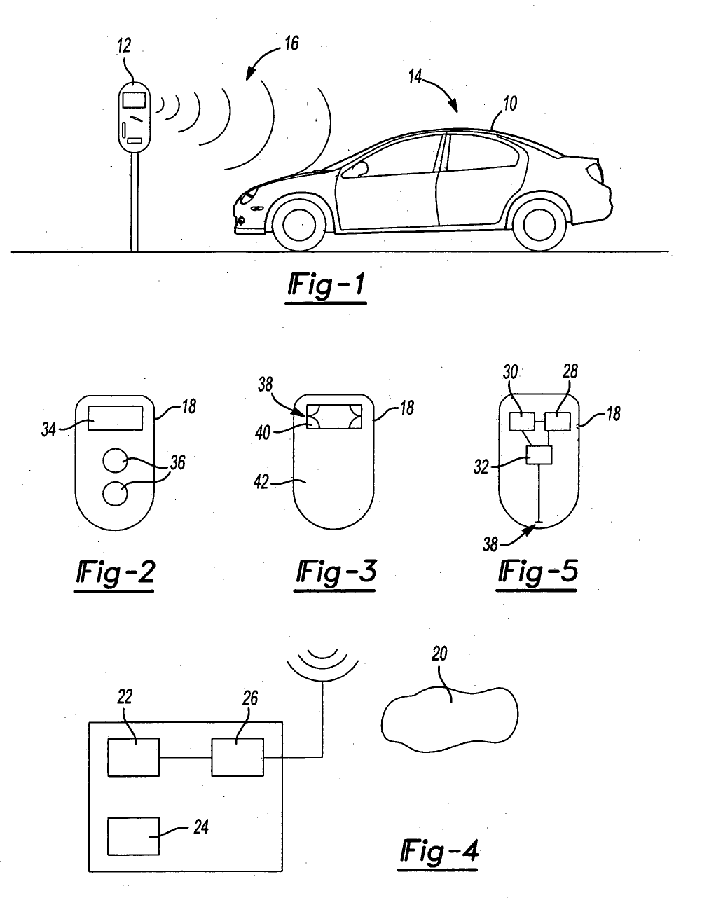

FIG. 1. a parking area with a transmitting device in accordance with the invention,

FIG. 2 a schematic top-view of a user terminal in accordance with the invention,

FIG. 3 a back side of the user terminal of FIG. 2,

FIG. 4 shown schematically, a block diagram of the transmitting device of FIG. 1 in accordance with the invention,

FIG. 5 shown schematically, a block diagram of the function blocks of the user terminal of FIG. 2,

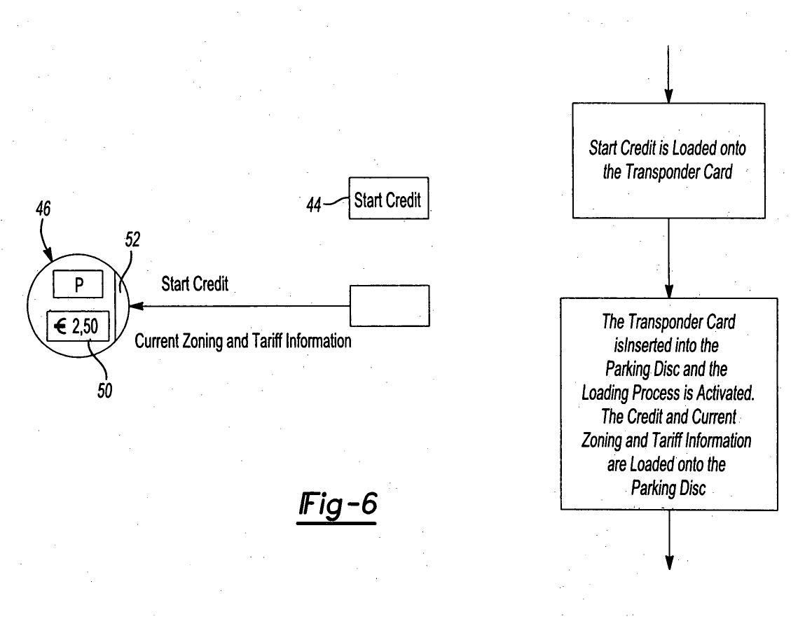

FIG. 6 shown schematically, a method for the initialization of an electronic parking disc in accordance with the invention,

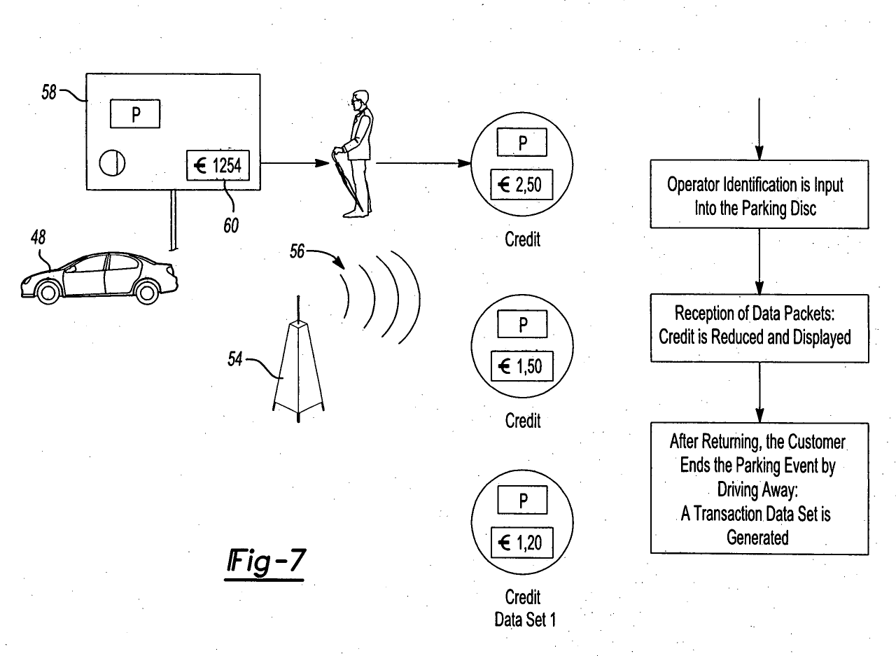

FIG. 7 shown schematically, the procedure of a first parking event with the electronic parking disc of FIG. 6,

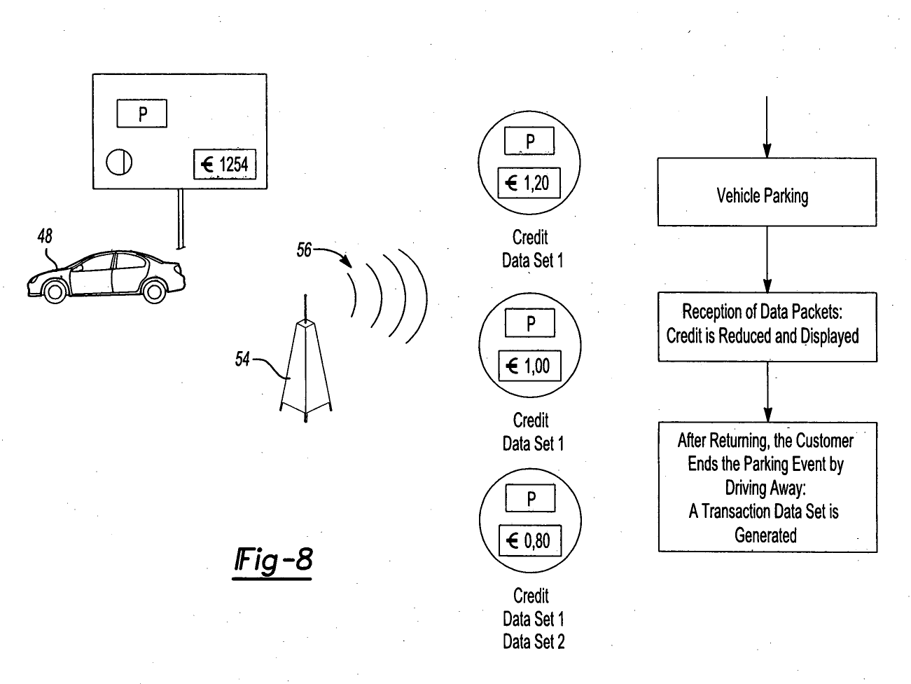

FIG. 8 shown schematically, a procedure of further parking events with the parking disc of FIG. 6,

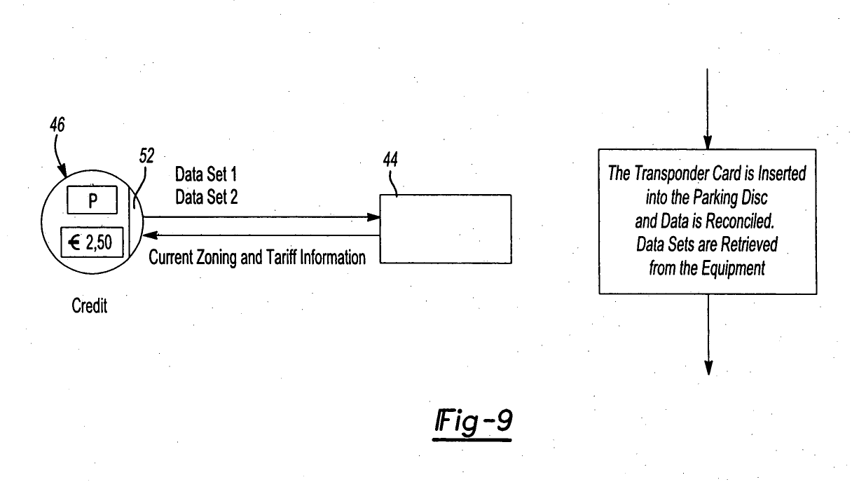

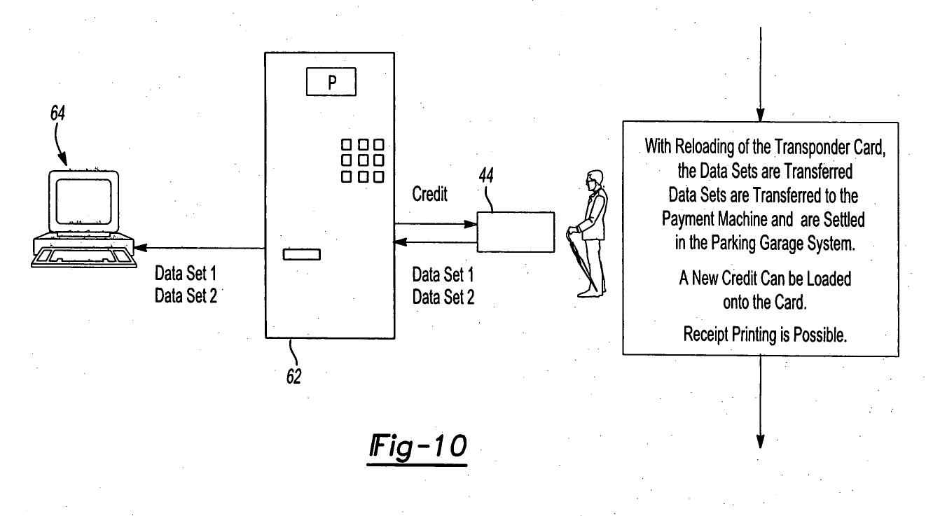

FIG. 9 shown schematically, the information flow of the communication of the electronic parking disc of the invention with a transponder card, and

FIG. 10 shown schematically, the use of the transponder card for data exchange.

A transmitting device 12 is illustrated in FIG. 1, which covers a parking area 14 with its transmitting range, in which parking area a vehicle 10 is parked. A user terminal 18 is located in the vehicle 10, not visible in FIG. 1, which user terminal receives data packets transmitted from the transmitting device 12 over a unidirectional radio connection 16.

The transmitting device 12 includes a data processing unit 22 (FIG. 4), which compiles the information provided in the data packets and transmits this. information as a data packets to the transmitting unit 24 of the transmitting device 12. The transmitting unit 24 is provided for the purpose of transmitting the data packets over a radio connection 16. The transmitting device 12 is powered by means of a network component 26, which supplies energy from a public energy supply network to the energy supply of the units of the transmitting device 12.

In the present embodiment, it is provided that the transmitting device 12 time discretely transmits the data packets, presently in minute cycles. Naturally, another time basis can also be selected or it can be provided that the data packets are transmitted in dependence upon different tariff time periods in different time intervals.

Presently, a data packet includes a company identification number, a sequence number, a date, a time, location information and a parking area identification. Furthermore, it is provided that the data packet includes an identification number of the transmitting unit 24. The data is provided in binary coded form and is assembled into a data packet, which is transferred to the transmitting unit 24 for the purpose of transmission over the radio connection 16.

FIG. 2 illustrates a user terminal 18 in accordance with the invention with a housing 42, which is presently constructed in a chip-card form. The user terminal includes an LCD display unit 34 as well as sensor keys 36 as an input unit. With the keys 36, the user terminal can be activated and/or deactivated, in which both keys 36 can be concurrently actuated in the present embodiment. Through the two key actuation, an accidental activation of the user terminal 18 can largely be avoided, in particular if, for example, the user terminal 18 is unintentionally actuated with the user pressing against one of the keys 36. Thus, for example, erroneous charging can be reduced in, for example, traffic situations with which the transmitting area of the transmitting device 12 engages the user terminal 18. With activation of the user terminal 18, a stored credit can be queried by actuation of lower key 36 in the activated condition. For this purpose, the display unit 34 is arranged for the alpha-numeric display, which enables mostly any character to be displayed.

The internal construction of the user terminal 18 is schematically illustrated in FIG. 5. The user terminal 18 includes a reception unit 30, which receives the data packets of the transmitting device 12 that are transmitted over. the radio connection 16. Along with the reception of the data packets, the reception unit 30 serves for the energy supply of the user terminal in order to ensure the intended function with regard to the reception and further processing of the data packets. For this purpose, the user terminal 18 includes a processing unit 32, which, not illustrated here, stands in communication connection with the keys 36 and the display unit 34. Further, a memory unit 28 is connected to the processing unit 32 and to the reception unit 30, which memory unit is appropriate for storing the data received with the data packet as well as a credit of the user terminal 18. Furthermore, the processing unit 32 is coupled to an interface 38, over which a wired communications connection with a not in detail illustrated loading terminal can be produced, with which, for example, the credit can be loaded or with which the determined parking time and parking positions can be transmitted to a likewise not in detail illustrated control center.

FIG. 3 illustrates a contact surface 40 on the back side of the user terminal 18, which forms the interface 38.

Because the housing 42 of the user terminal is designed as a chip-card, the possibility exists to load the credit onto the memory unit 28 at a conventional money-card terminal. Because money-card terminals meanwhile have a broad distribution, the user can load his user terminal 18 at any time and keep it operable with high flexibility and availability.

In a further embodiment, which is not illustrated in the drawings, a special loading terminal is provided, at which the user terminal 18 can be loaded with a credit. For this purpose, the loading terminal includes an input slot for the user terminal 18, in which a wired connection to the interface 38 is produced by means of corresponding spring contacts. The loading terminal then reads the stored data from the memory unit 28 over the processing unit 32 and transfers this to a not illustrated control center. This can make the data available for the purpose of further processing.

If the user terminal 18 is loaded with a credit, thus a corresponding currency amount is subsequently requested over the loading terminal. This can be settled either with a valid currency, such as cash, credit card, check card, cash card or the like, or it can also be charged by means of a debiting process from an account of the user. Upon a successful payment transaction, the corresponding credit is stored in the memory unit 28 of the user terminal 18 and stands available for a usage authorization.

In an alternative charging mode, it can be provided that the data that is transmitted to the control center is used for the charging instead of or in addition to a stored credit. This enables that the operator receives remittance of the corresponding fees through the control center with the use of the user terminal 18 at different parking areas with different operators. A simple and dependable payment of the parking fees can be achieved.

In order that it can be checked whether an authorization for parking exists for a parked vehicle, the function is provided that a signal is displayed with the reception of a special data packet in the user terminal 18, which signal enables an inspector to determine whether the user terminal is active and the parking fees are properly charged. For this, the inspector has a portable device with a Bluetooth interface, which transmits a corresponding data packet in the close-range radio area. If the inspector comes into the reception area of the user terminal 18 with a checking device and he transmits the special data telegram, for example activation via a key actuation, the user terminal 18 thusly reacts to the reception of the special data packet with a display of “OK” as confirmation that the intended operation is properly activated. If the user terminal 18 is switched off or the credit is depleted, no display appears.

In detail, it is provided that, for the function of the user terminal 18 in this embodiment, an amount from the current account, which is indicated in the data packet, is respectively charged in the memory unit 28. Thus, the amount to be charged can advantageously be smaller during periods of light use than a normal amount to be charged during regular usage times. Alternatively or additionally, it can be provided that the data packets are transmitted in different length time intervals. Also, through this, the charging process can be controlled in the user terminal 18.

FIG. 6 illustrates a further user terminal in accordance with the present invention, in the form of an electronic parking disc 46 with a coin shaped housing, which parking disc can be attached in an automobile 48, for example, to a windshield. The electronic parking disc 46 includes a display unit 50, which is presently formed as an LCD display, and which is so located that it is readable through the windshield. The electronic parking disc 46 further includes a slit 52, which is provided for the purpose that a transponder card 44 is inserted, so that a wireless communications connection can be produced between the transponder card 44 and the electronic parking disc 46. The contact areas are presently not further implemented. The wireless communications connection is produced in this case, however, by a close-range radio connection.

The initialization of the electronic parking disc 46 as well as of the transponder card 44 are described henceforth in the following. The user acquires the electronic parking disc 46 as well as the transponder card 44 at a corresponding sales outlet, such as a gas station or the like. The electronic parking disc 46 is appropriately located inside the automobile 48, so that the display unit 50 is readable through a window of the automobile 48. Initially, no credit is stored in the electronic parking disc 46.

The user further acquires at least one transponder card 44, which is provided with an authorization value in the form of a start credit. The user inserts the transponder card 44 into the slit 52 of the electronic parking disc, whereupon the start credit of the transponder card 44 is transferred to the electronic parking disc 46. During the transfer process and/or for a time period of 30 seconds after the ending of the transfer process, the start credit is displayed on the display unit 50 of the electronic parking disc 46. The electronic parking disc 46 is henceforth ready to be operated.

After completion of the transfer of the start credit to the electronic parking disc 46 from the transponder card 44, the user removes the transponder card 44 from the slit 52 of the electronic parking disc 46. With the transfer of the start credit, which here is classified as an authorization value, this value is set to zero in the transponder card 44. The transponder card 44 is purposefully carried by the user, in order to be able to provide this with a credit as required, at any time, at an apparatus that is provided for this purpose, in order to be able to refresh the electronic parking disc 46 therewith, as soon as this should be necessary.

In FIG. 7, a first parking event is illustrated. The user parks his vehicle 48 in a parking area that is not specifically indicated as a paid parking area. An information sign 58 that is located in the parking area provides an operator identification 60. By means of a, not specifically illustrated, input unit of the electronic parking disc 46, the user inputs the operator identification 60 into the electronic parking disc 46. From now on, the electronic parking disc 46 is automatically activatable and/or deactivatable. Data packets are transmitted over a unidirectional communications connection. 56 from a transmitting device 54. Each of the electronic parking discs 46 that are located in the reception area receives the data packets by means of a, not illustrated in detail, reception unit. A controller, which is provided in the electronic parking disc 46, detects the reception of the data packets and the reception field strength. The transmitting device 54 transmits data packets in an interval of 10 seconds. If five data packets from the same transmitting device 54 are received with an essentially constant reception field strength, this is detected as the beginning of the parking, and, with each additional data packet, the credit is reduced by an amount, which is provided in the respective data packet. Further action of the user is not necessary. If the parking period ends, the user gets back into his automobile 48 and drives out of the parking area. The electronic parking disc 46 henceforth obtains no further data packets or detects a strong decline in the field strength. This is detected as the end of parking and a corresponding data set is stored in the memory unit of the electronic parking disc 46. In the present embodiment, an action of the user for ending of the park time recordation is thusly not necessary.

Subsequently, if the user parks his vehicle anew in the parking area of the already registered operator (FIG. 8), the electronic parking disc 46 automatically detects the reception of data packets and starts the parking time determination. A further input of the operator identification is not necessary. Likewise, action of the user is not necessary. The parking time determination starts automatically. The expiration essentially corresponds to the above-identified process expiration. As soon as the user climbs into his vehicle and leaves the parking area, this is automatically detected by the electronic parking disc 46 and the parking time determination is discontinued. A second data set is compiled and is stored in the memory unit of the electronic parking disc 46.

The continued usage of the electronic parking disc 46 reduces the credit. The user can now again provide the electronic parking disc 46 with an additional credit. For this purpose, he uses the transponder card 44. He inserts this again into the slit 52 of the electronic parking disc 46. After a communications connection is produced between the electronic parking disc 46 and the transponder card 44, the data sets, here the data sets 1 and 2, are transmitted from the electronic parking disc 46 to the transponder card 44 and are stored within this. Concurrently, the data sets in the electronic parking disc 46 are deleted (FIG. 9).

The user now goes to an automated teller 62 (FIG. 10) with the transponder card 44. There, he inputs the transponder card 44 in an input slot that is provided for this purpose and that is not specifically indicated. Over the same interface, with which the transponder card 44 communicates with the electronic parking disc 46, the transponder card 44 produces a communications connection with the automated teller 62. In this connection, the existence of a mutual authorization is checked. The user selects a credit amount at the automated teller 62, that he wishes to store on the transponder card 44. He selects an appropriate payment means at the automated teller 62, presently the payment through cash. Naturally, other payment means such as credit card, debit card, smart card, debit note or the like can also be used. The automated teller 62 for its part produces a communications connection to a control center 64. From the transponder card 44, the data sets, here data sets 1 and 2, are read out and are transmitted to the control center 64 over the automated teller 62. There, the data sets are used for the settlement with the operators and for additional statistical purposes. In return, the control center 64 sends a release to the automated teller 62. With an actuation signal for the proper cash payment, a release signal is generated, with which a credit amount is stored as an authorization amount in a memory of the transponder card 44. The user can henceforth newly provide the electronic parking disc 46 with a credit using the transponder card 44, similar to the first initialization.

Naturally, a plurality of modifications can be provided without abandoning the inventive idea. Thus, the invention is not only usable for parking space management, in particular, it can also furthermore be implemented for the management of leisure devices, baths, sport devices or the like.

The exemplary embodiments do not limit the invention. In particular, several method steps can be interchanged or can be combined with one another without leaving the scope of the invention. Also, the embodiment of the several devices can vary. Thus, for example, instead of an LCD display unit, a simple light emitting diode or the like can be provided in order to display a corresponding signal.

### Reference Number List

10 vehicle

12 sending device

14 parking space

16 radio connection

18 user terminal

20 central

22 data processing unit

24 sending unit

26 network component

28 memory unit

30 receiving unit

32 processing unit

34 LCD display

36 keys

38 interface

40 contact surface

42 housing

44 transponder card

46 electronic park disk

48 vehicle

50 display unit

52 slit

54 sending device

56 unidirectional communication connection

58 instruction screen

60 user identification

62 pay machine

64 control center

1. A method for the automatic determination and charging for the use of a paid parking area, wherein data packets are transmitted from a transmitting apparatus in the area of the parking area over a wireless unidirectional communications connection, the data packets are received and further processed by a user terminal located in a vehicle that is parked in the parking area.

2. The method of claim 1, wherein the data packets are transmitted time discretely.

3. The method of claim 1 wherein the data packet contains at least one of the following information: an operator identification number, a sequence number, a date, a time, location information and/or a park area identification.

4. The method of claim 1 wherein a data packet uses an identification number of the user terminal.

5. The method of claim 1 wherein a data packet uses an identification number of a group of several user terminals.

6. The method of claim 1 wherein, by means of the user terminal, data sets regarding the parking beginning and/or the parking ending are generated from the received data packets and are stored.

7. The method of 1 wherein the user terminal indicates its current status.

8. The method of claim 7 wherein the indication is triggered by a special data packet.

9. The method of claim 7 t wherein the indication of the current status is time restricted.

10. The method of claim 7 wherein the current status is indicated based on a received signal energy.

11. The method of 7 wherein a prepaid credit is saved in the user terminal

12. The method of claim 11 wherein the credit is loaded.

13. The method of claim 11 wherein the loading occurs automatically.

14. The method of claim 11 wherein a value of a credit of an account is determined and is made available for loading over a network.

15. The method of claim 11 wherein the value of the to be loaded credit is established at a loading terminal that is coupled with the network.

16. The method of claim 11 wherein a fixed or pre-determinable amount is debited from the credit.

17. The method of claim 11 wherein an amount that is denoted in the data packet is debited.

18. The method of claim 11 wherein the to be debited amount from the user terminal is determined by means of the received data packet and an executable program stored in the user terminal.

19. The method of claim 1 wherein the use event is stored in the user terminal.

20. The method of claim 1 wherein a use event that is stored in the user terminal is conveyed to a control center during the loading of a credit onto the user terminal.

21. The method of claim 1 wherein the use events conveyed to the control center are used for the differentiation of the use of different operators.

22. The method of claim 1 wherein the receiving energy is used for the energy supply.

23. The method of claim 1 wherein the stored data is transferred to a control center.

24. The method of claim 1 wherein the user terminal is registered at the control center for the transfer of the data stored in the user terminal.

25. The method of claim 1 wherein the user terminal is de-registered after the transfer of the stored data.

26. The method of claim 1 wherein the user terminal communicates with an auxiliary unit through an interface.

27. The method of claim 26 wherein the data stored in the user terminal is transmitted to the auxiliary unit.

28. The method of claim 26 wherein the data received from the user terminal is transferred to the control center from the auxiliary unit.

29. The method of claim 1 wherein a credit is entered in the auxiliary unit.

30. The method of claim 1 wherein a credit is transferred from the auxiliary unit to the user terminal.

31. The method of claim 1 wherein the data stored in the user terminal is deleted after or with the transfer.

32. The method of that claim 1 wherein an operator identification number, a sequence number, a date, a time, location information and/or a park area identification is input into the user terminal.

33. The method of claim 1 wherein the data packet contains an identification of the transmitting device.

34-71. (canceled)
